(19) United States
(12) Patent Application Publication
(10) Pub. No.: US 2021/0191752 A1
(43) Pub. Date: Jun. 24, 2021

(54) DETERMINISTIC ALLOCATION OF SHARED RESOURCES

(71) Applicant: Seagate Technology LLC, Fremont, CA (US)

(72) Inventor: Robert Wayne Moss, Windsor, CO (US)

(21) Appl. No.: 16/946,081

(22) Filed: Jun. 5, 2020

Related U.S. Application Data
(60) Provisional application No. 62/950,446, filed on Dec. 19, 2019.

(51) Int. Cl. G06F 9/46; G06F 9/48; G06F 9/54; G06F 9/50; G06F 13/16; G06F 12/02

(52) U.S. Cl. CPC G06F 9/468; G06F 9/4806; G06F 12/0246; G06F 9/5016; G06F 13/1605; G06F 9/544

(57) ABSTRACT

Method and apparatus for deterministically arbitrating a shared resource in a system, such as a solid-state drive (SSD) operated in accordance with the NVMe (Non-Volatile Memory Express) specification. An NVM, such as a flash memory, is coupled to a controller circuit for concurrent servicing of data transfer commands from multiple users along parallel data paths that include a shared resource. A time cycle during which the shared resource can be used is divided into a sequence of time-slices, each assigned to a different user. The shared resource is thereafter repetitively allocated over a succession of time cycles to each of the users in turn during the associated time-slices. If a selected time-slice goes unused by the associated user, the shared resource remains unused rather than being used by a different user, even if a pending request for the shared resource has been issued.

### RELATED APPLICATION

The present application makes a claim of domestic priority under 35 U.S.C. 119(e) to U.S. Provisional Patent Application No. 62/950,446 filed Dec. 19, 2019, the contents of which are hereby incorporated by reference.

### SUMMARY

Various embodiments of the present disclosure are generally directed to a method and apparatus for managing the allocation of shared resources in a system, such as but not limited to a solid-state drive (SSD) operated in accordance with the NVMe (Non-Volatile Memory Express) specification.

In some embodiments, an NVM is coupled to a controller circuit for concurrent servicing of data transfer commands from multiple users along parallel data paths that include a shared resource. A time cycle during which the shared resource can be used is divided into a sequence of time-slices, each assigned to a different user. The shared resource is thereafter repetitively allocated over a succession of time cycles to each of the users in turn during the associated time-slices. If a selected time-slice goes unused by the associated user, the shared resource may remain unused rather than being used by a different user, even if a pending request for the shared resource has been issued.

These and other features and advantages which characterize the various embodiments of the present disclosure can be understood in view of the following detailed discussion and the accompanying drawings.

### BRIEF DESCRIPTION OF THE DRAWINGS

FIG. 1 provides a functional block representation of a data storage device constructed and operated in accordance with various embodiments of the present disclosure.

FIG. 2 illustrates the data storage device of FIG. 1 characterized as a solid state drive (SSD) that uses NAND flash memory in accordance with some embodiments.

FIG. 3 is a physical and functional layout of the flash memory of FIG. 2 in some embodiments.

FIG. 4 shows the grouping of various dies of the flash memory of FIG. 2 in various die and NVM set configurations in some embodiments.

FIG. 5 illustrates operation of a shared resource arbitration circuit to provide deterministic allocation of shared resources in the SSD in some embodiments.

FIGS. 6A and 6B show different types of time-slice allocations that can be carried out by the arbitration circuit.

FIG. 7 shows a configuration of the shared resource arbitration circuit of FIG. 5 in some embodiments.

FIG. 8 is a sequence diagram illustrating operations of the arbitration circuit in some embodiments.

FIG. 9 shows exemplary workload utilizations by various processes during different time-slices of an allocation cycle.

FIG. 10 is a graphical representation of improvements in data transfer rate performance achievable by the arbitration circuit.

### DETAILED DESCRIPTION

The present disclosure generally relates to systems and methods for managing data in a non-volatile memory (NVM).

Many current generation data storage devices such as solid-state drives (SSDs) utilize NAND flash memory to provide non-volatile storage of data from a host device. SSDs can be advantageously operated in accordance with the NVMe (Non-Volatile Memory Express) specification, which provides a scalable protocol optimized for efficient data transfers between users and flash memory.

NVMe primarily uses the PCIe (Peripheral Component Interface Express) interface protocol, although other interfaces have been proposed. NVMe uses a paired submission queue and completion queue mechanism to accommodate up to 64K commands per queue on up to 64K I/O queues for parallel operation. NVMe also supports the use of namespaces, which are regions of flash memory dedicated for use and control by a separate user (host). The standard enables mass storage among multiple SSDs that may be grouped together to form one or more namespaces, each under independent control by a different host. In similar fashion, the flash NVM of a single SSD can be divided into multiple namespaces, each separately accessed and controlled by a different host through the same SSD controller.

It can be advantageous when implementing NVMe to physically separate resources within an SSD so that each host can achieve a specified level of service. For example, dies in a flash memory may be segregated so that different sets of dies/channels are dedicated to different namespaces for use by different hosts. In this way, servicing one command from one host does not impact the servicing of another command from a different host and the SSD can process requests in parallel.

A limitation with this approach is that some resources must often be shared among different die sets. Examples of shared resources include, but are not limited to, various buffers, data paths, signal processing blocks, error correction blocks, etc. The shared resources can form bottlenecks that can degrade performance if certain host processes must wait until the necessary resources become available. This problem is exasperated during periods of I/O determinism (IOD), which are periods of time, as specified by the NVMe specification, during which a particular host can request guaranteed data transfer rate performance.

Various embodiments of the present disclosure address these and other limitations of the existing art by implementing a deterministic allocation approach to shared resources in a data storage system, such as but not limited to an SSD. As explained below, some embodiments operate by identifying each of a number of shared resources in the system, determining a steady-state workload that each resource can accommodate, equitably dividing up this workload among the various hosts (users) that may require the resource, and then strictly metering access to the shared resource among the hosts during the associated slots (“time-slices”). The solution can be implemented in hardware, firmware or both. In some cases, a separate throttling mechanism may be implemented for a particular host (such as during a period of IOD), etc.

A monitoring function allocates access to the resources in turn. In some embodiments, if a particular host does not require the use of the resource during its slot, the resource remains unused rather than being used by the next available host. In other embodiments, a voting system can be used among requestors so that each host obtains access in a fair and evenly distributed manner (such as adjusting the sizes of the time-slots based on priority, etc.). In still other embodiments, a host in a deterministic (IOD) mode may be allowed to use an unused time slot.

One aspect of the NVMe specification in general, and IOD mode more particularly, is the desirability of maintaining nominally consistent data transfer rate performance (e.g., command completion performance) over time for each host. It is generally better to have slightly lower I/O data transfer rates if such can be made more consistent. The various embodiments achieve this through the deterministic allocation of the shared resources used to service the various host processes of the users, as will now be discussed.

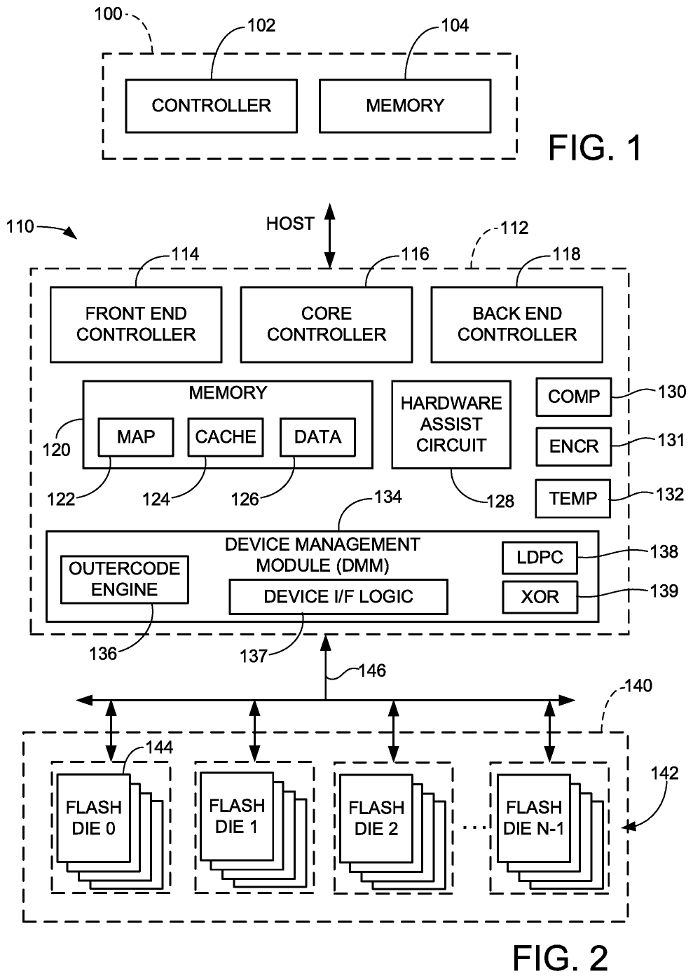

FIG. 1 provides a simplified functional block representation of a data storage device 100 constructed and operated in accordance with various embodiments of the present disclosure. The device 100 is characterized as a solid-state drive (SSD) that employs non-volatile semiconductor memory such as 3D NAND flash memory, although the present disclosure is not so limited. In other embodiments, the data storage device 100 can take other forms including but not limited to a hybrid solid state drive (HSSD), a hard disc drive (HDD), etc.

The device 100 includes a controller circuit 102 which provides top-level control and communication functions as the device interacts with a host device (not shown) to store and retrieve host user data. A memory module 104 provides a non-volatile memory (NVM) to provide persistent storage of the data. In some cases, the NVM may take the form of an array of flash memory cells.

The controller 102 may be a programmable CPU processor that operates in conjunction with programming stored in a computer memory within the device. The controller may alternatively be a hardware controller. The controller may be a separate circuit or the controller functionality may be incorporated directly into the memory array 104.

As used herein, the term controller and the like will be broadly understood as an integrated circuit (IC) device or a group of interconnected IC devices that utilize a number of fundamental circuit elements such as but not limited to transistors, diodes, capacitors, resistors, inductors, waveguides, circuit paths, planes, printed circuit boards, memory elements, etc. to provide a functional circuit regardless whether the circuit is programmable or not. The controller may be arranged as a system on chip (SOC) IC device, a programmable processor, a state machine, a hardware circuit, a portion of a read channel in a memory module, etc.

In order to provide a detailed explanation of various embodiments, FIG. 2 has been provided to describe relevant aspects of an exemplary data storage device 110 corresponding to the device 100 of FIG. 1. The SSD 110 is shown in FIG. 2 to be configured as a solid state drive (SSD) that communicates with one or more host devices via one or more Peripheral Component Interface Express (PCI) ports. The NVM is contemplated as comprising NAND flash memory, although other forms of solid state non-volatile memory can be used.

In at least some embodiments, the SSD operates in accordance with the NVMe (Non-Volatile Memory Express) specification, which enables different users to allocate NVM sets (die sets) for use in the storage of data. Each die set may form a portion of an NVMe namespace that may span multiple SSDs or be contained within a single SSD. Each namespace will be owned and controlled by a different user (host). While aspects of various embodiments are particularly applicable to devices operated in accordance with the NVMe specification, such is not necessarily required.

The SSD 110 includes a controller circuit 112 with a front end controller 114, a core controller 116 and a back end controller 118. The front end controller 114 performs host I/F functions, the back end controller 118 directs data transfers with the memory module 114 and the core controller 116 provides top level control for the device.

Each controller 114, 116 and 118 includes a separate programmable processor with associated programming (e.g., firmware, FW) in a suitable memory location, as well as various hardware elements to execute data management and transfer functions. This is merely illustrative of one embodiment; in other embodiments, a single programmable processor (or less/more than three programmable processors) can be configured to carry out each of the front end, core and back end processes using associated FW in a suitable memory location. A pure hardware based controller configuration can alternatively be used. The various controllers may be integrated into a single system on chip (SOC) integrated circuit device, or may be distributed among various discrete devices as required.

A controller memory 120 represents various forms of volatile and/or non-volatile memory (e.g., SRAM, DDR DRAM, flash, etc.) utilized as local memory by the controller 112. Various data structures and data sets may be stored by the memory including one or more map structures 122, one or more caches 124 for map data and other control information, and one or more data buffers 126 for the temporary storage of host (user) data during data transfers.

A non-processor based hardware assist circuit 128 may enable the offloading of certain memory management tasks by one or more of the controllers as required. The hardware circuit 128 does not utilize a programmable processor, but instead uses various forms of hardwired logic circuitry such as application specific integrated circuits (ASICs), gate logic circuits, field programmable gate arrays (FPGAs), etc.

Additional functional blocks can be realized in or adjacent the controller 112, such as a data compression block 130, an encryption block 131 and a temperature sensor block 132. The data compression block 130 applies lossless data compression to input data sets during write operations, and subsequently provides data de-compression during read operations. The encryption block 131 applies cryptographic functions including encryption, hashes, decompression, etc. The temperature sensor 132 senses temperature of the SSD at various locations.

A device management module (DMM) 134 supports back end processing operations and may include an outer code engine circuit 136 to generate outer code, a device I/F logic circuit 137, a low density parity check (LDPC) circuit 138 and an XOR (exclusive-or) buffer 139. The elements operate to condition the data presented to the SSD during write operations and to detect and correct bit errors in the data retrieved during read operations.

A memory module 140 corresponds to the memory 104 in FIG. 1 and includes a non-volatile memory (NVM) in the form of a flash memory 142 distributed across a plural number N of flash memory dies 144. Flash memory control electronics (not separately shown in FIG. 2) may be provisioned on each die 144 to facilitate parallel data transfer operations via a number of channels (lanes) 146.

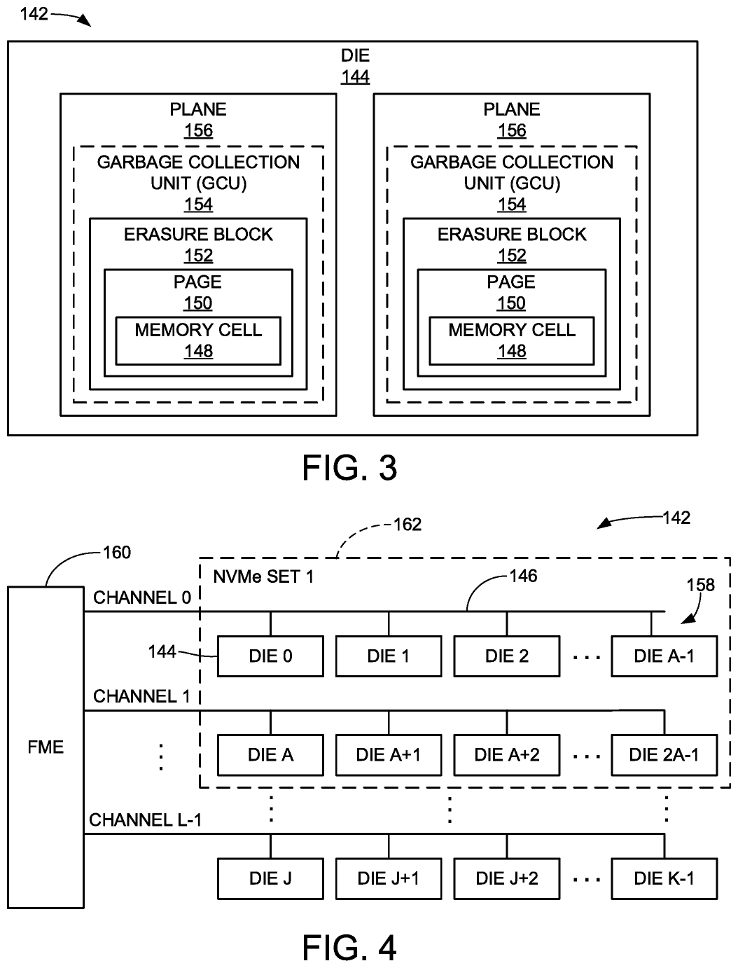

FIG. 3 shows a physical/logical arrangement of the various flash memory dies 144 in the flash memory 142 of FIG. 2 in some embodiments. Each die 144 incorporates a large number of flash memory cells 148. The cells may be arrayed in a two-dimensional (2D) or three-dimensional (3D stacked) arrangement with various control lines (e.g., source, bit, word lines) to access the cells.

Groups of cells 148 are interconnected to a common word line to accommodate pages 150, which represent the smallest unit of data that can be accessed at a time. Depending on the storage scheme, multiple pages of data may be written to the same physical row of cells, such as in the case of MLCs (multi-level cells), TLCs (three-level cells), QLCs (four-level cells), and so on. Generally, n bits of data can be stored to a particular memory cell 148 using 2ⁿ different charge states (e.g., TLCs use eight distinct charge levels to represent three bits of data, etc.). The storage size of a page can vary; some current generation flash memory pages are arranged to store 16 KB (16,384 bytes) of user data. Other configurations can be used.

The memory cells 148 associated with a number of pages are integrated into an erasure block 152, which represents the smallest grouping of memory cells that can be concurrently erased in a NAND flash memory. A number of erasure blocks 152 are turn incorporated into a garbage collection unit (GCU) 154, which are logical storage units that utilize erasure blocks across different dies as explained below. GCUs are allocated and erased as a unit, and tend to span multiple dies.

During operation, a selected GCU is allocated for the storage of user data, and this continues until the GCU is filled. Once a sufficient amount of the stored data is determined to be stale (e.g., no longer the most current version), a garbage collection operation can be carried out to recycle the GCU. This includes identifying and relocating the current version data to a new location (e.g., a new GCU), followed by an erasure operation to reset the memory cells to an erased (unprogrammed) state. The recycled GCU is returned to an allocation pool for subsequent allocation to begin storing new user data. In one embodiment, each GCU 154 nominally uses a single erasure block 152 from each of a plurality of dies 144, such as 32 dies.

Each die 144 may further be organized as a plurality of planes 156. Examples include two planes per die as shown in FIG. 3, although other numbers of planes per die, such as four or eight planes per die can be used. Generally, a plane is a subdivision of the die 144 arranged with separate read/write/erase circuitry such that a given type of access operation (such as a write operation, etc.) can be carried out simultaneously by each of the planes to a common page address within the respective planes.

FIG. 4 shows further aspects of the flash memory 142 in some embodiments. A total number K dies 144 are provided and arranged into physical die groups 158. Each die group 158 is connected to a separate channel 146 using a total number of L channels. Flash memory electronics (FME) circuitry 160 of the flash memory module 142 controls each of the channels 146 to transfer data to and from the respective die groups 158. In one non-limiting example, K is set to 128 dies, L is set to 8 channels, and each physical die group has 16 dies. In this way, any of the 16 dies physically connected to a given channel 146 can be accessed at a given time using the associated channel. Generally, only one die per channel can be accessed at a time.

In some embodiments, the various dies are arranged into one or more NVMe sets. An NVMe set, also referred to a die set or a namespace, represents a portion of the storage capacity of the SSD that is allocated for use by a particular host (user/owner). NVMe sets are established with a granularity at the die level, so that each NVMe set will encompass a selected number of the available dies 144.

An example NVMe set is denoted at 162 in FIG. 4. This set 162 encompasses all of the dies 144 on channels 0 and 1, for a total of 32 dies. Other arrangements can be used. In one embodiment that will be discussed more fully below, the NVM 142 is divided into four equally sized namespaces (e.g., the second namespace utilizes all of the dies on channels 2 and 3; the third namespace utilizes all of the dies on channels 4 and 5; and the fourth namespace utilizes all of the dies on channels 6 and 7). This arrangement allows each of the namespaces to be accessed independently; for example, read/write operations can be carried out in parallel to the respective namespaces without die/channel conflicts among the respective users.

It is contemplated that the SSD 110 will nevertheless have a number of resources that must be shared among the various hosts (users/owners of the namespaces) in order to carry out these and other types of memory accesses. With reference again to FIG. 2, such shared resources may include the map control mechanisms used to retrieve, utilize and update the map data 122; the compression and encryption engines 130, 131 used to process write and read data; the LDPC encoding/decoding circuits 138; the XOR buffers 139; and so on.

While these and other types of shared resources can be operated efficiently, it can be expected that there will be times when multiple host processes, which are operations carried out by the SSD to service access commands issued by the various hosts, require the use of these and other elements at the same time. The allocation of shared resources by existing solutions may tend to provide fair levels of use on average when viewed over an extended period of time, but can lead to significant variations in I/O performance, which can be undesirable from a system standpoint.

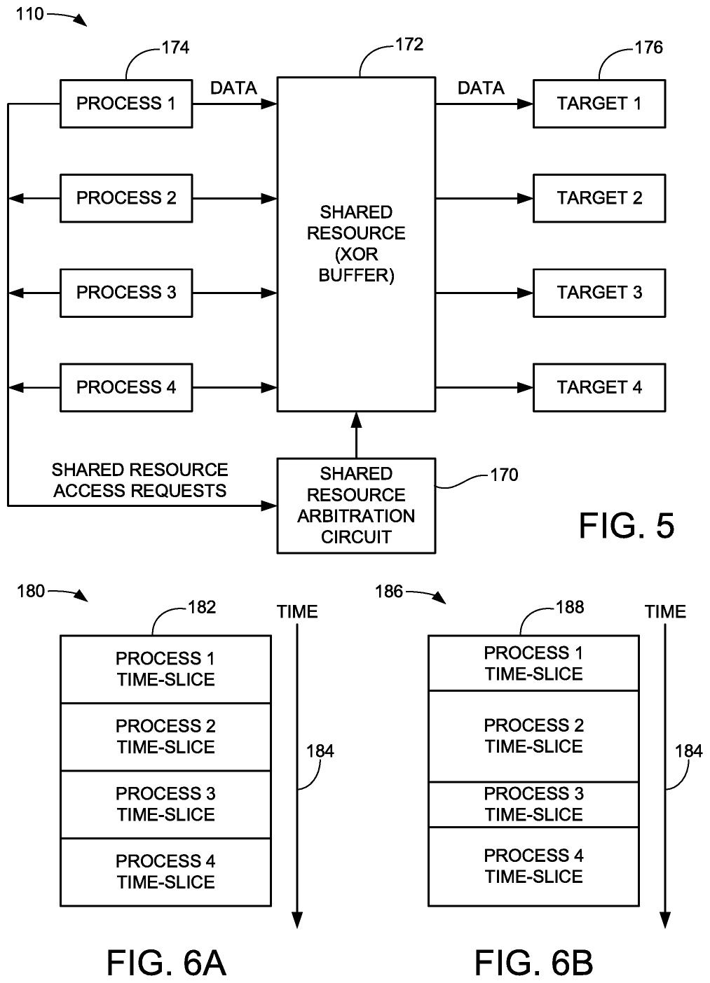

Accordingly, FIG. 5 provides a functional block representation of a shared resource arbitration circuit 170 of the SSD 110 in accordance with various embodiments. The arbitration circuit 170 forms a portion of the controller 112 (FIG. 2) and may be realized in hardware and/or programmable instructions (e.g., firmware) executed by one or more programmable processors.

A shared resource of the SSD 110 is generally represented at 172. The shared resource is accessed as required by four (4) different processes 174, each associated with a different host/namespace. The shared resource 172 serves as a bottleneck as the respective processes endeavor to access various targets 176.

The shared resource 172 can take any suitable form, including the various examples listed above. For purposes of providing a concrete example, FIG. 5 contemplates the shared resource is an XOR buffer used to calculate outercode parity values in each block of data written to flash, referred to as a parity set. For example, 31 pages of user data to be written to flash may be successively combined in the buffer via XOR to generate a final, 32^{nd} page in the parity set, after which the completed parity set is written to a selected GCU (with each page written to a different die in the GCU; see FIGS. 3-4).

It follows that the host processes 174 may be write threads and the targets 176 are die/channel combinations and associated write circuitry to write the parity sets to the respective NVMe sets in the flash 142. The XOR buffer 172 can only be used by a single write thread 174 at a time. Requests to access and use the shared resource may be issued by the processes to the arbitration circuit 170 as shown, although such are not necessarily required.

The arbitration circuit manages access to the XOR buffer, as well as to each of the other shared resources in the SSD 110, by evaluating the capabilities of the shared resource and the needs of the respective hosts, and by generating a predetermined time-cycle profile with slots, or time-slices, during which each of the respective hosts can sequentially access and use the resource.

FIG. 6A shows a first time-cycle profile 180 in which each of the processes 174 from FIG. 5 is assigned a time-slice 182 of equal duration. It will be appreciated that the time-slices may be measured in terms of elapsed time (e.g., X microseconds, Y clock periods, etc.), or may be measured in some other manner (e.g., Z calculations, etc.). Regardless, each host is allotted an opportunity to utilize the shared resource during its own time-slice over each cycle. The overall duration of the cycle is indicated by arrow 184, after which the cycle successively repeats.

FIG. 6B shows a second time-cycle profile 186 in which each of the processes 174 from FIG. 5 is assigned a time-slice 188 of different duration. Process 2 is afforded a larger time slice as compared to Process 3, and so on. This may be scaled based on priority, respective storage capacities of the associated namespaces, observed workload, etc. The scaling is initially set and can be adaptively adjusted over time.

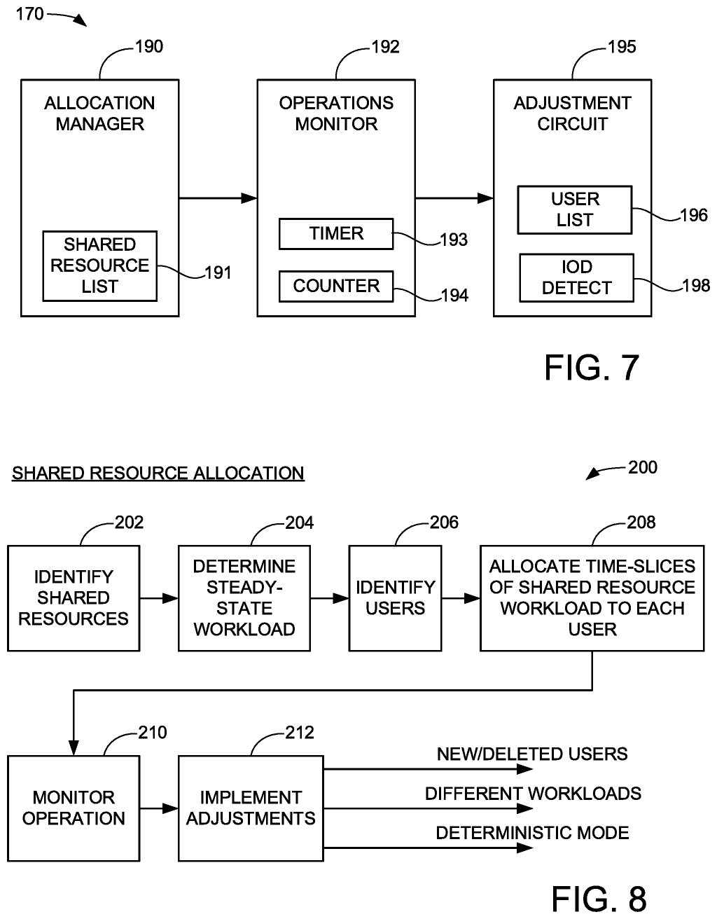

FIG. 7 shows a functional block representation of the arbitration circuit 170 from FIG. 5 in accordance with some embodiments. An allocation manager 190 maintains a shared resource list 191 as a data structure in memory to list the various shared resources in the system, as well as associated control data for each resource.

The allocation manager 190 assesses the workload capabilities of each resource. This can be carried out in a number of ways, such as in terms of IOPS, data transfers, calculations, clock cycles, and so on. The workload capability of each resource may be specified or empirically derived during system operation. Using the XOR buffer example from FIG. 5, the allocation manager 190 operates to determine, on average, how long the XOR buffer is needed to complete the parity calculations for some selected number of parity sets that may be written to the flash at a time. Once the workload capability is determined, the allocation manager assigns the duration of the associated time-slice for each host (e.g., 182, FIG. 6A). A small amount of transitioning time may be included in each time-slice to enable efficient switching between processes.

An operations monitor 192 monitors system operation as the shared resource is used by the respective hosts in accordance with the predetermined profile. A timer 193, a counter 194, or other mechanisms may be utilized by the monitor to switch between the competing processes and maintain the predetermined schedule. The monitor 192 also collects utilization data to evaluate system performance.

The hosts are strictly limited to use of the shared resource only during the allotted time-slices. This is true even if a particular host does not require the use of the resource during one of its time-slices and other hosts have issued pending requests; the resource will simply go unused during that time-slice. Alternative embodiments in which hosts may be permitted to utilize unused time-slices under certain conditions will be discussed below.

An adjustment circuit 195 of the arbitration circuit 170 operates as required to make adjustments to an existing profile under certain circumstances. These changes may be short or long term. For example, if a first user exhibits a greater need for the resource (e.g., operation in an extended write dominated environment) as compared to a second user (e.g., operation in an extended read dominated environment), a larger time-slice may be allocated to the first user at the expense of the second user. In this way, the predetermined time-slices may be adaptively adjusted over time in view of changing operational conditions.

Other factors that can influence the time-cycle profile for a given shared resource can include the addition or removal of a user, the periodic entry into deterministic mode by the respective users, etc. To this end, a user list 196 can be used as a data structure in memory to track user information and metrics, and an IOD detection unit 198 can detect and accommodate periodic IOD modes by the respective users in turn.

FIG. 8 is a sequence diagram 200 to illustrate operation of the arbitration circuit 150 in accordance with some embodiments. Other sequences can be carried out as desired. Initially, the circuit operates as shown at block 202 to identify the various shared resources in the system. Generally, a shared resource will be a circuit, element or other aspect of the system that at least potentially requires utilization by two or more users at the same time to complete respective tasks associated with the users.

It will be appreciated that not every element that may be shared will necessarily be controlled as a shared resource by the arbitration circuit 170; for example, the main processors in the controller 112, the memory 120, the host interfaces, etc. may be arbitrated and divided among the various users using a different mechanism. Nevertheless, other elements, particularly elements of the type that lie along critical data paths to transfer data to and from the flash memory 142, may be suitable candidates for arbitration by the sequence 200.

The arbitration circuit 170 proceeds at block 204 to determine the steady-state workload capabilities of each shared resource controlled by the circuit. Some shared resources (such as buffers) may operate in a relatively predictable manner, so the steady-state capabilities can be selected as the typical or average cycle time necessary to successfully complete the associated function.

Other shared resources (such as error correction decoding circuitry) may fluctuate wildly in the required time to complete tasks; for example, a shared error decoder circuit may decode code words retrieved from the flash memory in anywhere from a single iteration to many iterations (potentially even then without complete success). Rather than selecting the worst-case scenario, some arrangement of time, iterations, etc. sufficient to enable the task to be completed in most cases (within some predetermined threshold) will likely result in a suitable duration for each time-slice. In some cases, priority can be advanced and the arbitration temporarily suspended if significant time is required to resolve a particular condition.

Block 206 proceeds to identify the various users, such as different hosts assigned to different namespaces, and time-slices are allocated to each of these respective users at block 208. This results in a predetermined profile for each shared resource, such as illustrated in FIGS. 6A and 6B.

System operation is thereafter carried out, and the use of the shared resources in accordance with the predetermined profiles is monitored at block 210. As required, adjustments to the predetermined profiles are carried out as shown by block 212. Reasons for adjustments may include a change in the number of users, changes and variations in different workloads, the use of deterministic mode processing by the individual users, etc.

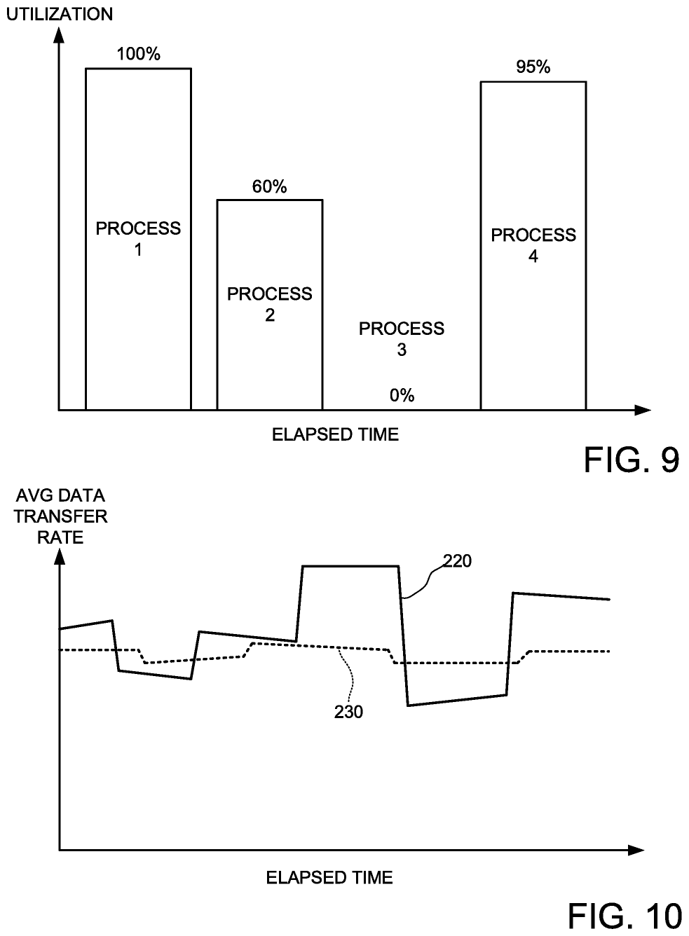

FIG. 9 is a graphical representation of workload utilization by each of the example processes 174 from FIG. 5 over a particular time-cycle. This is merely for purposes of illustration; it is contemplated that, depending on user demand, the shared resources will usually tend to be utilized heavily by each of the competing users.

In this case, the first process (Process 1) fully utilized the shared resource at a level of 100% during its particular time-slice. Process 2 utilized the resource for 60% of its time-slice. Process 3 did not utilize the shared resource at all (0%), and Process 4 utilized it for 95% of its time-slice.

There are a number of possible reasons why a process (such as Process 3) may not utilize a resource during a scheduled slot. Delays in error coding or decoding, write failure indications, busy die indications, etc. may prevent that particular process from being ready to use the shared resource during a particular cycle. In such case, the process can utilize the resource during its slot in the next time-cycle.

As noted above, the monitor circuit strictly limits access to the shared resource during each of the respective time-slices, and normally will not allow a user to access the time-slice of another user, even if pending access requests are present. It may seem counter-intuitive to not permit use of a valuable shared resource in the presence of pending requests, but the profiles provided by the arbitration circuit enable each of the processes to be optimized and consistent over time. Because the arbitration circuit only makes the shared resources available at specific, predetermined times, various steps can be carried out upstream of the resources to flow the workload through the system in a more consistent manner.

FIG. 10 is a graphical representation of data transfer rate performance curves 220, 230. The curves are plotted against an elapsed time x-axis and an average data transfer rate y-axis. The y-axis can be quantified in a number of ways, such as overall average data transferred per unit of time (e.g., gigabits/sec, etc.), average command completion time, average delta between command submission and command completion, and so on. The x-axis is contemplated as extending over many successive time-cycles.

The solid curve 220 indicates exemplary transfer rate performance of the type that may be achieved using conventional shared resource arbitration techniques. Dotted curve 230 represents exemplary transfer rate performance of the type that may be achieved using the arbitration circuit 170. While curve 220 shows periods of higher performance, the response is bursty and has significant variation. By contrast, curve 230 provides lower overall performance, but with far less variability which is desirable for users of storage devices, particularly in NVMe environments.

It is contemplated that the monitor circuit 192 will evaluate these and other types of system metrics. If excessive variation in output data transfer rate is observed, adjustments to the existing shared resource profiles may be implemented as required. In some cases, operation of the profiles may be temporarily suspended and the circuit may switch to a more conventional form of arbitration, such as a first-in-first-out (FIFO) arrangement based on access requests for the shared resource.

It is not necessary to have the various processes submit requests to the arbitration circuit for the shared resource, provided the arbitration circuit signals to the respective processes when the resource is available. The use of requests for the shared resource can still be helpful, however, as this will enable the monitor circuit to evaluate the utilization of the shared resource, including the extent of any backlogged conditions. Returning to the example of FIG. 9, should Process 3 continue to not require the use of the shared resource for a number of successive cycles, it may be appropriate to allow one or more of the other processes to utilize this time-slice, particularly if the amount of backlog exceeds a predetermined threshold. Regardless whether the processes submit requests for the shared resource, the arbitration mechanism may include a termination mechanism to forcibly evict a given process from the resource to enforce the time policies.

In further cases, periods of deterministic (IOD) mode by a selected user may cause the arbitration circuit to promote the IOD user to use the shared resource if the shared resource is not otherwise going to be used by a different one of the users. In this case, the arbitration circuit may require the various processes to signal a request in sufficient time prior to the next upcoming time-slice to claim its slice, else the slice will be given to a different user. Nevertheless, it is contemplated that the arbitration circuit will maintain strict adherence to the predetermined schedule since all of the hosts will optimally be planning the various workload streams based on the availability of the resources at the indicated times.

It will now be appreciated that the various embodiments present a number of benefits. By predetermining time-slices as periods of scheduled intervals during which each of multiple users (hosts/processes/users) can utilize a shared resource, more efficient workflow rates can be achieved. While the system may result in the shared resource not being utilized during certain periods, the overall benefits to the flow of the system outweigh the short term advantages that such operations would otherwise provide. Intelligent mechanisms can be implemented to throttle the system up or down as required to maintain the ultimate goal of nominally consistent host-level performance.

While various embodiments presented herein have been described in the context of the use of one or more users of a particular SSD, it will be appreciated that the embodiments are not so limited; the resources can take any number of forms, including one or more SSDs (or other devices) that are used at a system level in a multi-device environment such as caches, etc. Moreover, while it is contemplated that the various embodiments have particularly suitability for use in an NVMe environment, including one that supports deterministic (IOD) modes of operation, such are also merely illustrative and are not limiting.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method for deterministically arbitrating a shared resource, comprising:
coupling a non-volatile memory (NVM) to a controller circuit for concurrent servicing of data transfer commands from multiple users along parallel data paths that include a shared resource;
dividing a time cycle during which the shared resource can be used into a sequence of time-slices each assigned to a different user; and
repetitively allocating, over a succession of the time cycles, the shared resource to each of the users in turn during the associated time-slices, the shared resource remaining unused during a selected time-slice during which the associated user does not utilize the shared resource.

2. The method of claim 1, wherein the associated user that does not utilize the shared resource during the selected time-slice is a first user, and wherein a request for use of the shared resource from a second user is pending but denied during the selected time-slice.

3. The method of claim 1, wherein 1 to N time-slices in the time cycle are respectively assigned to 1 to N users in a selected order, and wherein during each time cycle the users are granted access for use of the shared resource during the associated time-slices in the selected order.

4. The method of claim 1, wherein the users are configured to issue requests to utilize the shared resource, wherein the associated user did not issue a request for use of the shared resource during the selected time-slice, and wherein the shared resource remained unused during the selected time-slice irrespective of a presence of one or more pending requests for the shared resource from at least one other user.

5. The method of claim 1, further comprising identifying a sustainable workload capability of the shared resource, and allocating the time-slices to each of the users in relation thereto.

6. The method of claim 1, wherein each of the time-slices assigned to each of the corresponding users is of equal duration.

7. The method of claim 1, wherein each of the time-slices assigned to each of the corresponding users has a different duration.

8. The method of claim 1, further comprising monitoring a performance metric associated with each of the users, and adjusting a duration of at least one time-slice in response thereto.

9. The method of claim 1, wherein the NVM is a flash memory of a solid-state drive (SSD) operated in accordance with the NVMe (Non-Volatile Memory Express) specification, and wherein each of the users is associated with a different namespace within the flash memory.

10. The method of claim 9, further comprising detecting whether a selected user is in a deterministic mode or a non-deterministic mode, wherein the shared resource remains unused during the selected time-slice responsive to the selected user being in the non-deterministic mode, and wherein the shared resource is used during the selected time-slice responsive to the selected user being in the deterministic mode.

11. A data storage device, comprising:
a non-volatile memory (NVM);
a controller circuit configured to concurrently servicing data transfer commands from multiple users along parallel data paths;
a shared resource through which each of the parallel data paths pass; and
a shared resource arbitration circuit configured to identify a time cycle as an elapsed period of time during which the shared resource can be used by each of the multiple users in turn to complete a task, to divide the time cycle into a plurality of time-slices, to assign each time-slice assigned to a different user, and to respectively allocate the shared resource to each of the users in turn over a succession of consecutive time cycles, the shared resource arbitration circuit disallowing use of the shared resource by the respective users except during the assigned time-slices of each time cycle.

12. The data storage device of claim 11, wherein the NVM is divided into a plurality of NVMe (Non-Volatile Memory Express) namespaces, and each user comprises a host process associated with a different one of the namespaces.

13. The data storage device of claim 12, wherein each of the namespaces comprises a different NVMe die set comprising a different combination of semiconductor memory dies and corresponding channel paths, and the shared resource comprises a circuit utilized by each of the different namespaces to transfer data between the NVM and a host device.

14. The data storage device of claim 13, wherein the shared resource comprises a selected one of a buffer, an error decoding circuit or a signal processing block.

15. The data storage device of claim 11, wherein each of the users are configured to issue requests for use of the shared resource, wherein the shared resource remains unused during a selected time-slice associated with a first user irrespective of a presence of a pending request for use of the shared resource from a second user during the selected time-slice.

16. The data storage device of claim 11, wherein 1 to N time-slices in the time cycle are respectively assigned to 1 to N users in a selected order, wherein during each time cycle the users are granted access for use of the shared resource during the associated time-slices in the selected order, and wherein during each time cycle each user is denied access for use of the shared resource during the time-slices that are associated with the remaining users.

17. The data storage device of claim 11, wherein the shared resource arbitration circuit allocates the time-slices to each of the users in relation to a sustainable workload capability of the shared resource.

18. The data storage device of claim 11, wherein each of the time-slices assigned to each of the corresponding users is of equal duration.

19. The data storage device of claim 11, wherein each of the time-slices assigned to each of the corresponding users has a different duration.

20. The data storage device of claim 11, wherein the NVM is a flash memory of a solid-state drive (SSD) operated in accordance with the NVMe (Non-Volatile Memory Express) specification, and wherein each of the users is associated with a different namespace within the flash memory.
